(19) United States
(12) Patent Application Publication
(10) Pub. No.: US 2014/0106078 A1
(43) Pub. Date: Apr. 17, 2014

(54) Universal Paint Grid

(71) Applicant: DRIPLESS, INC., Santa Rosa, CA (US)

(72) Inventor: Larry C. Childs, Cotati, CA (US)

(73) Assignee: DRIPLESS, INC., Santa Rosa, CA (US)

(21) Appl. No.: 13/651,346

(22) Filed: Oct. 12, 2012

(51) Int. Cl. B44D 3/12; B05C 17/02

(52) U.S. Cl. CPC B44D 3/12; B05C 17/0245
USPC 427/428.01; 15/257.06

(57) ABSTRACT

A paint grid for removing excess fluid from a roller type applicator. The paint grid comprises a sheet of material having a plurality of openings therein. The sheet has a length and a width that is less than its length. The sheet has a substantially planar central portion and sloped edge margins extending from the central portion. The sloped edge margins include a sloped edge margin extending lengthwise along one edge of the sheet and a sloped edge margin extending widthwise along another edge of the sheet.

### FIELD OF INVENTION

The present invention relates generally to equipment and methods for applying a coating of paint or similar fluid to an object, and more particularly to equipment and methods for loading a roller cover with paint or similar fluid contained in a container so the roller cover can be used to transfer the paint or other fluid to the surface of an object.

### BACKGROUND

Various different types of paint brushes, sponges, and other applicators are available to apply a coating of paint or other fluid to a wall or other object. One type of applicator that has long been available is a nap roller. As will be readily understood by those familiar with painting, a paint roller includes a handle that supports a rotatable spindle. A support (e.g., an elongate tube made of cardboard) can be secured to the spindle by sliding the support over the outer circumference of the spindle. An absorbent material referred to as the nap or pile is secured to the outer surface of the support to form what is commonly referred to as a roller cover. When the roller cover is positioned on the spindle, the handle can be used to position the roller cover in contact with the surface of an object to be painted. Moreover, once the roller cover is in contact with the surface, the handle can be moved to cause the roller cover to roll across the surface of the object. If paint or other fluid has been absorbed by the roller cover, some of the paint is transferred to the surface of the object as the roller cover rolls over the surface of the object.

To load or reload the roller cover with paint, the handle is moved to dip at least a portion of the roller cover into a reservoir of paint. When the roller cover is withdrawn from the paint reservoir, it is typically overloaded with paint to the point that movement of the roller cover from the reservoir to the object being painted will very likely result in paint undesirably dripping off the roller cover. This wastes paint and requires cleanup and/or precautions against getting paint on the floor or other objects that are not supposed to be painted. It is also desirable in some cases to dip only a portion of the roller cover into the paint (e.g., to limit the amount of paint that gets on the ends of the spindle or portions of the handle), in which case the paint may not be evenly distributed through the roller cover.

One way to address this problem is to transfer a portion of the paint from a container to a separate tray that includes a small reservoir for paint and a ramp extending into the reservoir from one side. After the roller cover is loaded with paint, it can be rolled up and down the ramp a few times to distribute the paint more evenly within the roller cover and to transfer some of the excess paint to the ramp to facilitate movement of the roller cover to the object being painted with less risk of dripping. This solution results in inefficient use of paint, because some of the paint dries on the ramp and other portions of the tray and cannot be used to paint the object being painted. It is also inefficient to transfer paint from the original paint container into the tray and then later pour any unused paint back into the original container. Moreover, the small reservoir in the tray has to be refilled frequently and time spent refilling the tray adds to the time required to complete a project.

Another option is to insert a paint grid (or paint screen) into the container of paint. A paint grid is a sheet of perforated material (often expanded metal) that is sized and shaped to fit into a bucket of paint so a lower end of the grid rests on the bottom of the container and an upper end of the screen extends above the top of the container. An example of a paint grid of this sort is described in U.S. Pat. No. 5,283,928. Alternatively, the lower end of a paint grid can be suspended above the bottom of the container (e.g., by using hooks on the upper end of the paint screen to hand the paint grid on the upper rim of the container). An example of a paint grid that can be suspended above the bottom of the container is provided in U.S. Pat. No. 7,036,182.

To use a paint grid, a roller cover is rolled up and down on the perforated sheet after being loaded with paint while at least a portion of the paint grid is in the container and before moving the roller cover from the paint container to the object being painted. As the roller cover rolls over the perforated sheet of material excess paint is removed from the roller cover and the paint absorbed by the roller cover is distributed more evenly within the roller cover. The excess paint falls from the paint grid right back into the reservoir of paint in the container.

Although the prior art paint grids are generally effective, the present inventor has made improvements thereto, which are described in detail below.

### SUMMARY

In one aspect, the present invention includes a paint grid for removing excess fluid from a roller type applicator. The paint grid comprises a sheet of material having a plurality of openings therein. The sheet has a length and a width that is less than the length. The sheet also has a substantially planar central portion and sloped edge margins extending from the central portion. The sloped edge margins include a sloped edge margin extending lengthwise along one edge of the sheet and a sloped edge margin extending widthwise along another edge of the sheet.

In another aspect of the invention, a paint grid for removing excess fluid from a roller type applicator comprises a sheet of material having a plurality of openings therein and legs extending from the sheet material. The legs support a plurality of feet spaced apart from the sheet. The feet extend radially inward from the legs toward the central portion of the sheet. The feet also have radially outward facing surfaces that are rounded.

In another respect, the present invention includes a method of painting. The method includes positioning a paint grid so it has a first orientation and extends into a first paint container. The paint grid includes a sheet that has a plurality of openings therein. The sheet also has a length and a width that is less than its length. At least a portion of a roller applicator is dipped into a reservoir of paint in the first paint container to load the roller applicator with paint from the first paint container. The roller applicator is rolled up and down on the sheet of the paint grid and is used to paint with paint from the first paint container. The method also includes repositioning the paint grid so it has a second orientation different from the first orientation. In its second orientation, the paint grid extends into a second paint container, which has a different size than the first container. At least a portion of a roller applicator is dipped into a reservoir of paint in the second paint container to load the roller applicator with paint from the second paint container. The roller applicator is rolled up and down on the sheet of the paint grid and is used to paint with paint from the second paint container.

Other aspects and features will in part be apparent and in part pointed out hereinafter.

### BRIEF DESCRIPTION OF THE DRAWINGS

FIG. 1 is a perspective illustrating an embodiment of a universal paint grid of the present invention;

FIG. 2 is a top plan of the universal paint grid of FIG. 1;

FIG. 3 is a rear elevation of the universal paint grid of FIG. 1;

FIG. 4 is a left side elevation of the universal paint grid of FIG. 1;

FIG. 5 is a bottom plan of the universal paint grid of FIG. 1;

FIGS. 7 and 8 are enlarged perspectives from two different vantage points of a cross sectioned portion of the universal paint grid of FIG. 1 taken in a plane including line 7-7 on FIG. 5;

FIGS. 9 and 10 are a side elevation and top plan, respectively, showing the universal paint grid of FIG. 1 positioned in a two-gallon bucket;

FIGS. 11 and 12 are a side elevation and top plan, respectively, showing the universal paint grid of FIG. 1 positioned in a five-gallon bucket; and

FIG. 13 illustrates one embodiment of a method of switching the universal paint grid of FIG. 1 between two containers that are different in size.

Corresponding reference characters indicate corresponding parts throughout the drawings.

### DETAILED DESCRIPTION

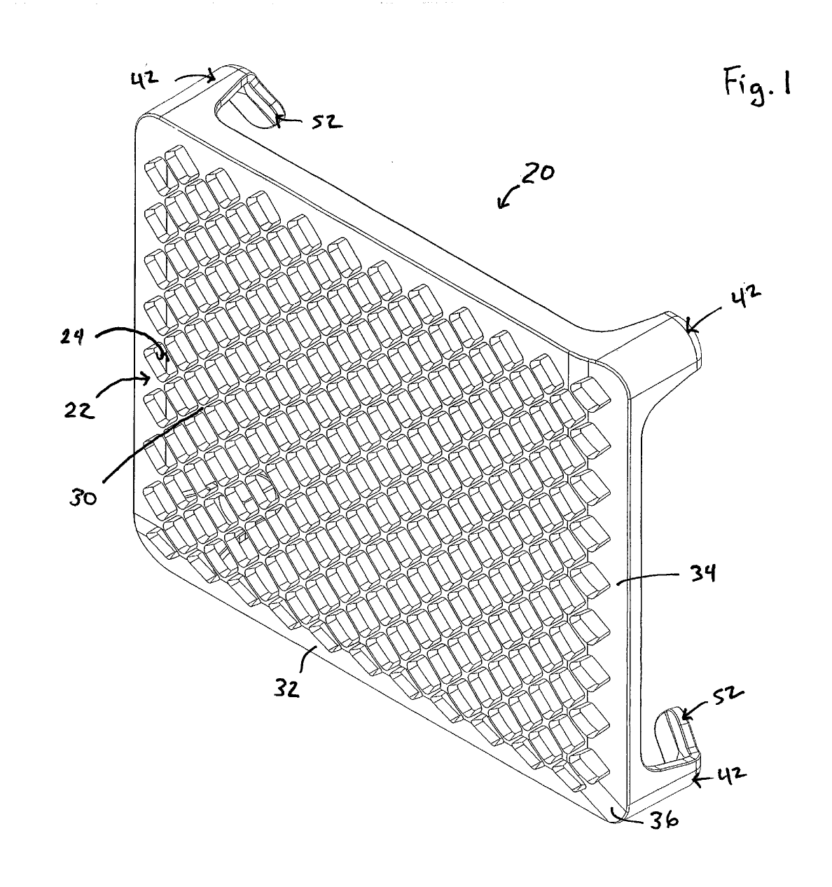

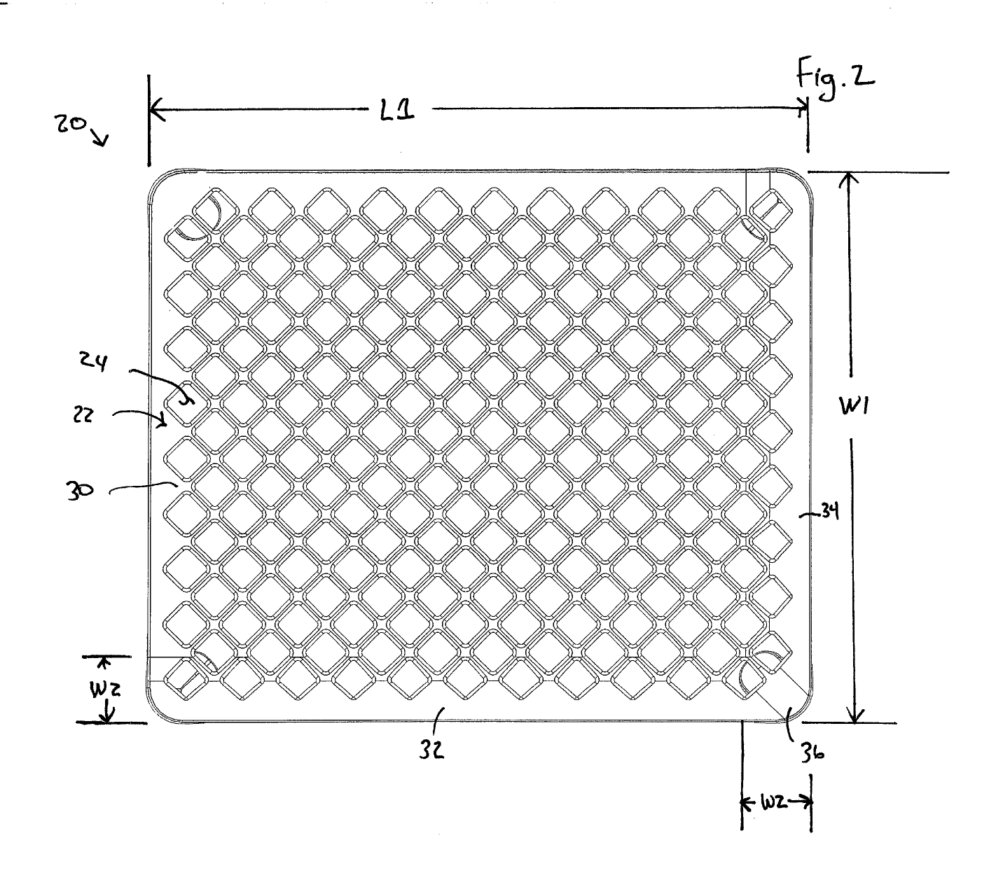

Referring to FIGS. 1-8, a universal paint grid for removing excess fluid from a roller type applicator is designated in its entirety by the reference number 20. The paint grid 20 has a sheet of material 22 having a plurality of openings 24 therein. As illustrated in FIG. 2, the openings 24 in sheet 22 are generally diamond-shaped. The shape of the openings 24 shown in this embodiment is merely illustrative and the openings could have other shapes within the scope of the invention. The sheet 22 has a length L1 and width W1 that is less than the length. The sheet 22 includes a substantially planar central portion 30 and sloped edge margins 32 and 34 which extend from the central portion. One sloped edge margin 32 extends lengthwise along one edge of sheet 22, and another sloped edge margin 34 extends widthwise along another edge of the sheet. As illustrated in the drawings, the sloped edge margins 32 and 34 suitably extend along two adjacent sides of the sheet 22, which is generally rectangular. Further, in the illustrated embodiment the sloped edges 32, 34 each extend substantially continuously all the way along the respective edge of the sheet 22.

In the illustrated embodiment, the sloped edge margins 32, 34 of the sheet 22 meet at a corner 36 of the sheet, where the edges of the sheet intersect. The corner 36 is sloped relative to the central portion 30 of sheet 22. The paint grid 20 suitably has a continuous smooth contour through the transition from one sloped edge 32, around the corner 36, to the other sloped edge 34. Although the embodiment illustrated in the drawings has a rounded and sloped corner 36, other corner shapes may be used within the broad scope of the invention. For example, rounded corner 36 could be replaced with a sharp or discontinuous junction between edge margins 32 and 34. Likewise, it is possible that the sloped edges 32, 34 extend only part of the way along their respective edges within the broad scope of the invention.

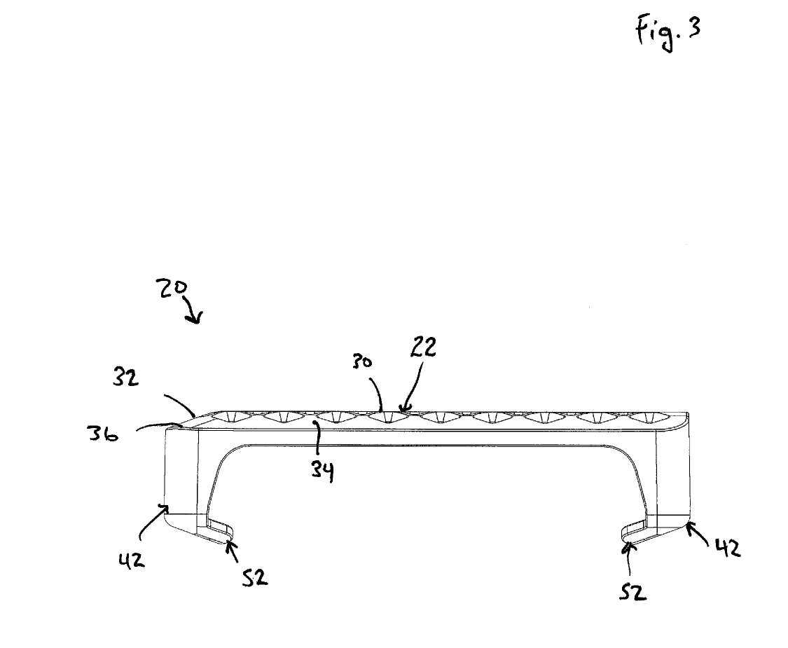

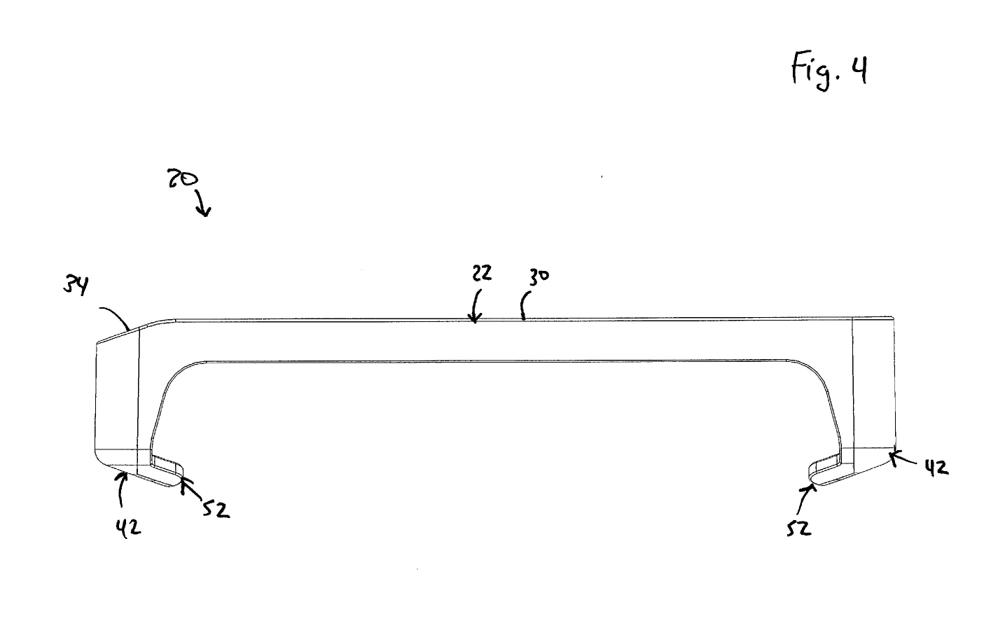

It is suitable but not required that sloped edge margins 32 and 34 have a width W2 (FIGS. 3 and 4) that is at least about a quarter inch and more suitably at least about a half inch. In the illustrated embodiment, each of the sloped edge margins 32, 34 has about the same width W2, but this is not required. The sloped edge margins 32 and 34 are suitably disposed at an angle A1 (FIGS. 3 and 4) in the range of about 5 degrees to about 45 degrees, and more suitably in the range of about 15 to about 35 degrees, relative to the substantially planar central portion 30. In the illustrated embodiment, edge margins 32 and 34 are each disposed at the same angle A1 relative to the central portion 30, but this is not required within the broad scope of the invention. In other embodiments, edge margins 32 and 34 could be of non-uniform widths or non-uniform angles relative to the central portion of the grid. Likewise, in the illustrated embodiment, sloped edge margins 32 and 34 are substantially planar, but the sloped edge margins could have non-planar surfaces (e.g., gently curved) within the scope of the invention. Moreover, sloped edge margins 32 and 34 could have a width and/or angle outside of the ranges described above without straying from the broad scope of this invention.

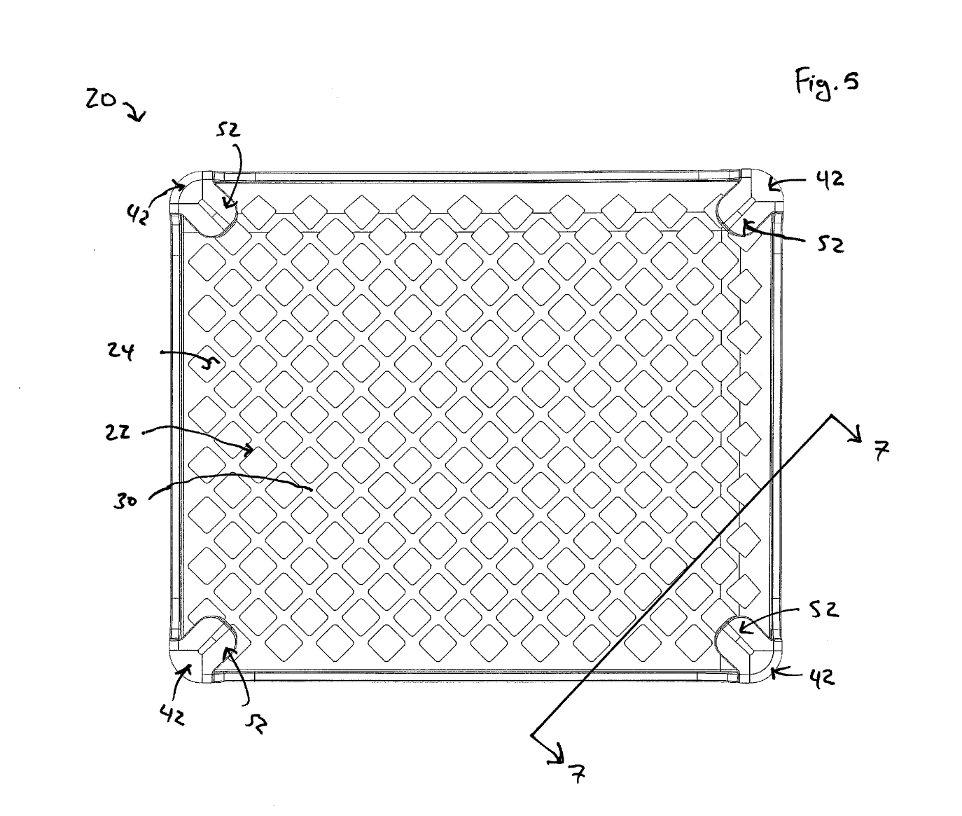

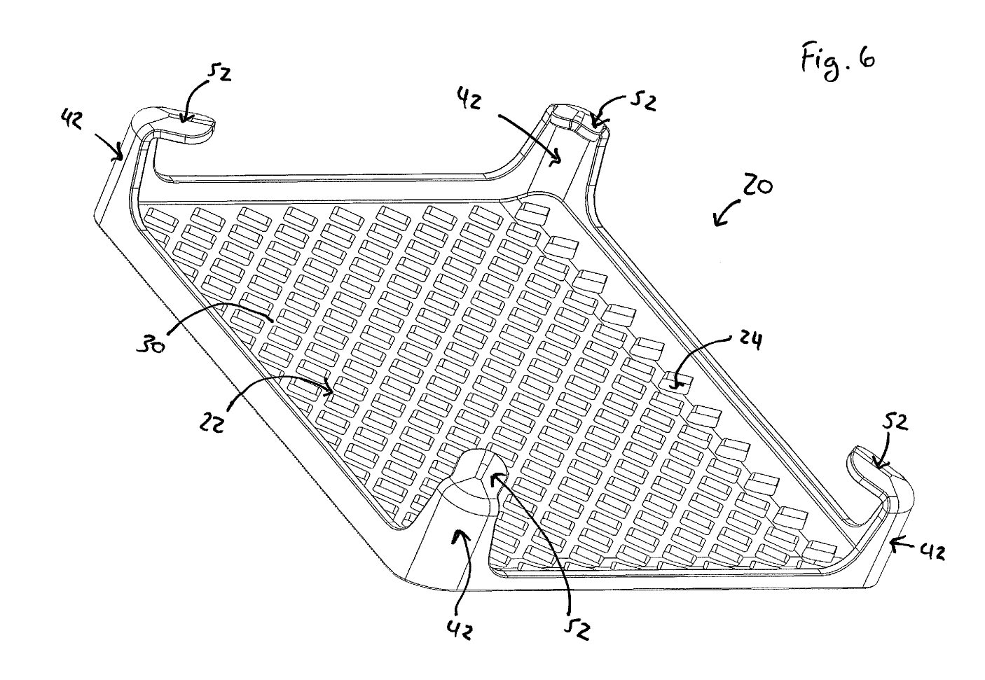

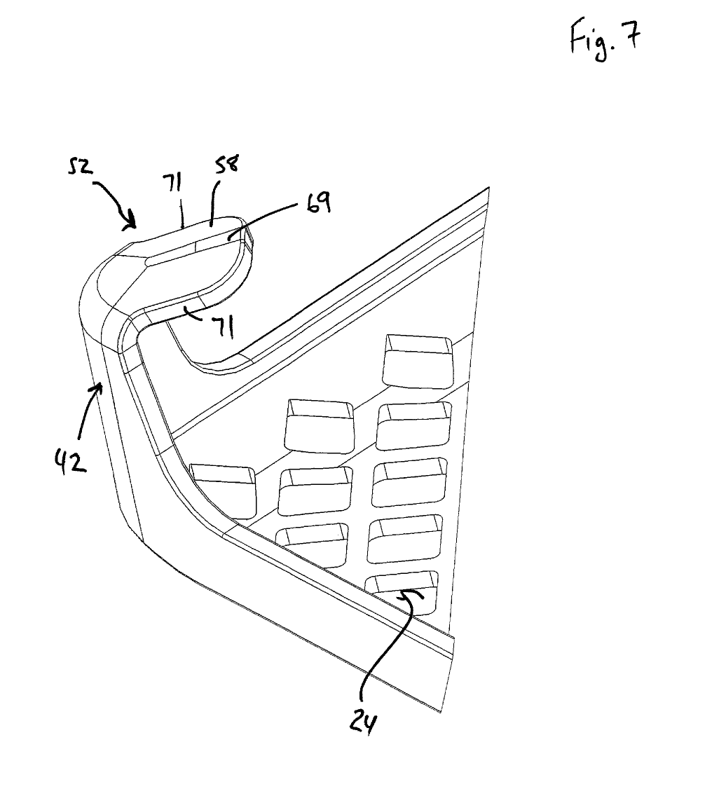

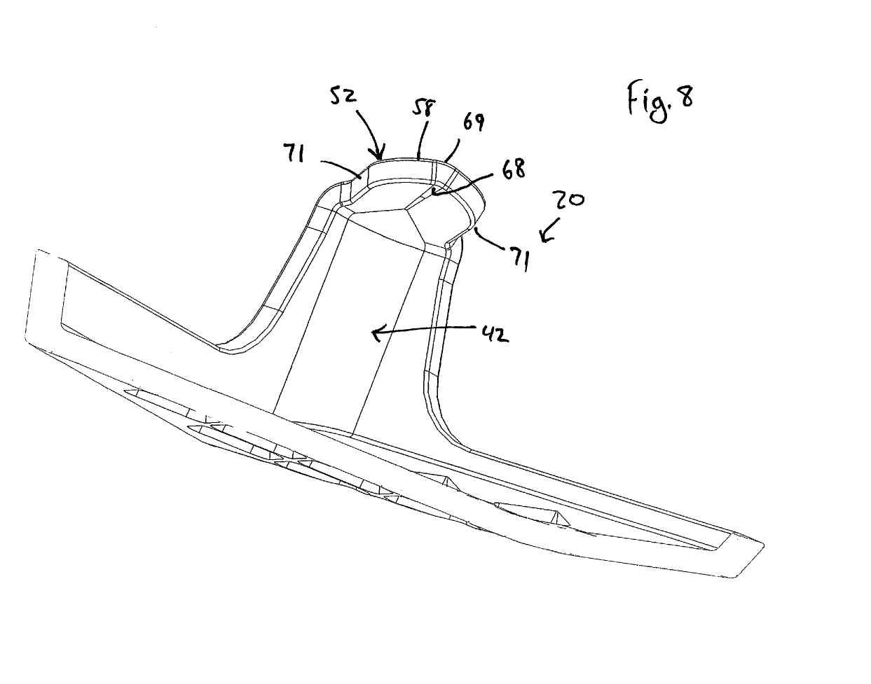

Referring to FIGS. 5-8, the paint grid 20 includes a plurality of legs 42 (e.g. four legs) extending from the sheet 22. For example, in the illustrated embodiment, one leg 42 extends from each corner of the rectangular sheet 22. The legs 42 of the illustrated paint grid 20 support a plurality of feet 52 that are spaced from the sheet 22. Each leg 42 suitably supports one foot 52 so in the case of four legs, for example, there are suitably four feet. The legs 42 and feet in the illustrated embodiment are all identical. Each foot 52 extends radially inward from the respective leg 42 toward the central portion 30 of sheet 22. Referring to FIGS. 7 and 8, each leg 42 has a radially outward facing surface 58 that is rounded, for reasons that will be discussed in more detail below. In the illustrated embodiment, the feet 52 are integrally formed with the respective leg 42. However, it is understood the feet could be formed separately from the legs and secured to legs (e.g., using mechanical fasteners such as screws, bolts, rivets, etc. or other suitable means) within the scope of the invention.

The feet 52 extend away from the sheet 22 as they extend radially inward toward the central portion 30 of the sheet 22. FIG. 6 shows a close up perspective of one of the legs 44 and the foot 52 it supports. As illustrated in FIG. 8, each foot 52 is configured to have a concave channel 68 oriented so the open side of the channel faces generally toward the sheet 22. A rounded ridge 69 extends along the opposite side of the foot. The opposite sides 71 of the foot 52 extend away from the channel 68 and ridge 69 to form a V-shape oriented so the open end of the V is pointed toward the bottom of the sheet 22. The V-shaped configuration of the foot 52 makes the foot resistant to bending and increases durability of the feet.

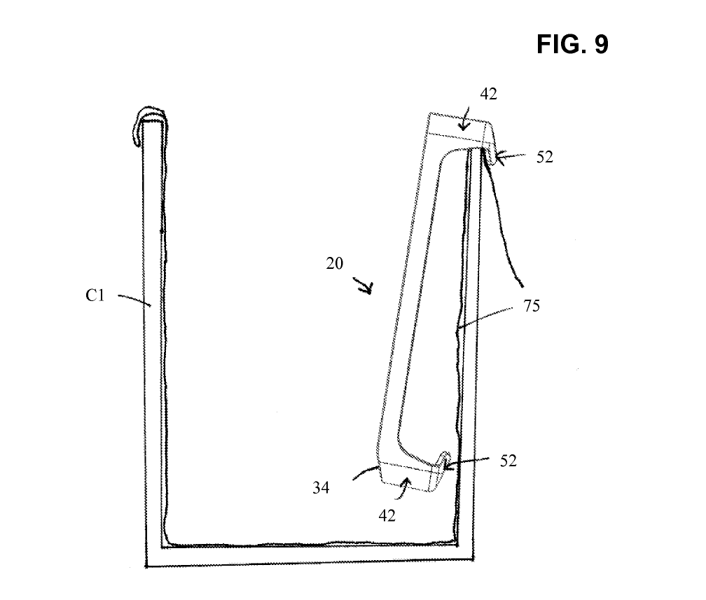

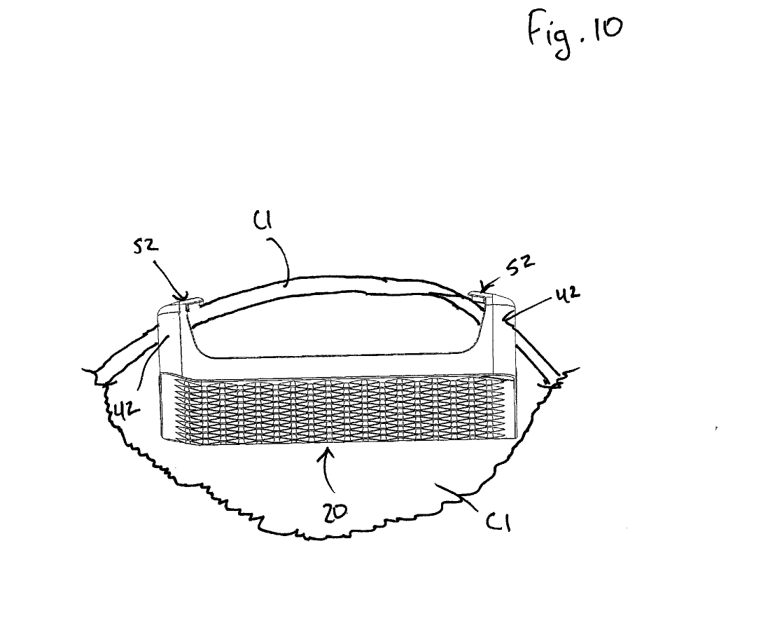

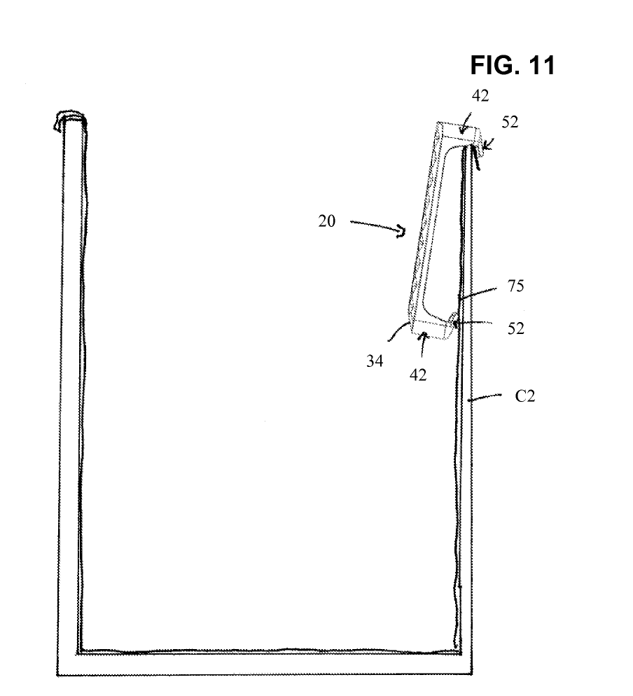

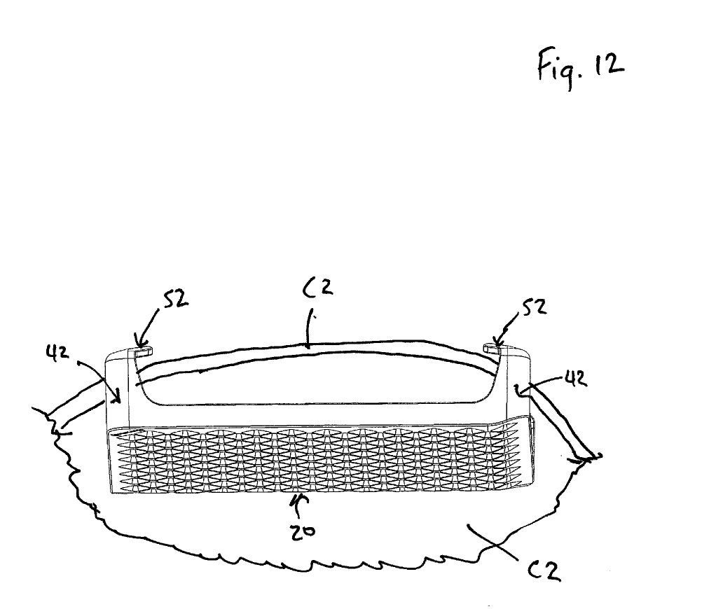

The legs 42 are configured to hang the paint grid 20 on an upper rim of a paint container so the sheet 22 extends into the container. In a first orientation (FIGS. 9 and 10), two of the legs 42 are positioned over the rim of a container C1 so the paint grid 20 extends lengthwise into the container. The widthwise axis of the sheet 22 is therefore oriented generally horizontally or generally parallel to an imaginary plane including the container rim. In a second orientation (FIGS. 11 and 12), a different pair of legs 42 are positioned over the rim of a container C2 having a configuration (e.g., size or shape) that is different from the first container C1 so the paint grid extends widthwise into the container. In this orientation, the lengthwise axis of the sheet 22 is oriented generally horizontally or generally parallel to the imaginary plane including the container rim. The ability to hang the paint grid 20 in two different orientations facilitates use of the paint grid with different sizes of container, as will be explained in more detail below.

The paint grid 20 is suitably made of a resilient flexible polymeric material (e.g., polypropylene). For example, the entire paint grid 20 can suitably be molded as a unitary body (e.g., in an injection molding process). However, other materials and manufacturing methods may be used within the scope of the invention.

One embodiment of a method of using the paint grid 20 is illustrated in FIGS. 9-13. Referring to FIGS. 9 and 10, the paint grid 20 is positioned so it has a first orientation and extends into a first paint container C1.

Positioning the paint grid 20 so it extends into first paint container C1 suitably positions the paint grid so it extends substantially all the way to the bottom of the container. Two of legs 42 and feet 52 are hooked over the rim of the first container to hold the paint grid in position, as illustrated in FIG. 9. The sheet 22 of the paint grid 20 is suitably angled away from the side wall of container C1 as it extends into the container. The feet 52 that hook over the rim of the container C1 may contact the exterior container side wall of the first container along at least a portion of their radially inward extending length. Moreover, the concave channels of the feet 52, match the contour of the exterior sidewall of a typical cylindrical container better that a planar surface would. The bottom two legs 42 can be positioned near or at the bottom of first container C1. The sloped edge margin 34 that extends along the shorter end of the paint grid 20 is positioned at the lower end of the paint grid in this orientation. The other sloped edge margin 32 extends vertically along the side of the paint grid 20 in this orientation.

At least a portion of a roller applicator (not shown) is dipped into a reservoir of paint in the first paint container C1 to load the roller applicator with paint from the first paint container. The paint-loaded roller applicator is then rolled up and down on sheet 22 of paint grid 20. Rolling the paint loaded roller applicator up and down on sheet 22 urges excess paint from the roller nap. The excess paint will tend to fall through openings 24 into the paint reservoir where it can be reloaded onto the roller applicator for use in coating a surface. A user can roll the roller applicator across sheet 22 until the roller nap contains a desired amount of paint. Once the desired amount of paint is obtained, the roller applicator is used to coat a surface with paint from the first paint container. The sloped edge margin 34 at the bottom of the paint grid 20 in this orientation facilitates the ability to roll the applicator up and down on the sheet because if the applicator is rolled down below the bottom edge of the paint grid there is a more gentle transition when resuming upward movement because of the angle of the sloped edge margin. Moreover, it is contemplated that users can learn to feel when the roller transitions from the planar central portion 30 of the sheet onto the sloped edge margin 34 and thereby avoid rolling the applicator past the bottom edge of the paint grid on the down stroke.

The paint grid 20 can be repositioned so it has a second orientation different from the first orientation, as shown in FIGS. 11 and 12. Two of the legs 42 and feet 52 are hooked over the rim of a container C2, which may be the same container C1 or a different container, in a similar manner as described above. However, in the second orientation, the paint grid 20 is positioned so the sloped edge margin 32 that extends along the longer side of the paint grid is positioned at the bottom edge of the paint grid. The other sloped edge margin 34 extends vertically along the side of the paint grid 20 in this orientation. The sloped edge margin 32 at the bottom of the paint grid facilitates the ability to roll an applicator up and down on the sheet 22 during use of the paint grid in the same ways described above.

In the first orientation, the paint grid 20 can extend farther into the container and spans a relatively shorter distance in the lateral direction. Conversely, in the second orientation, the legs 42 and feet 52 that are hooked over the rim of the container support the paint grid so the bottom of the paint grid does not extend as far into the container and the paint grid spans a relatively greater distance in the lateral direction. Different users may have different preferences for the orientation. One orientation may be preferred over the other depending on variables such as the amount of paint remaining in the container, the size of the roller applicator being used, the size and/or shape of the container and/or other factors.

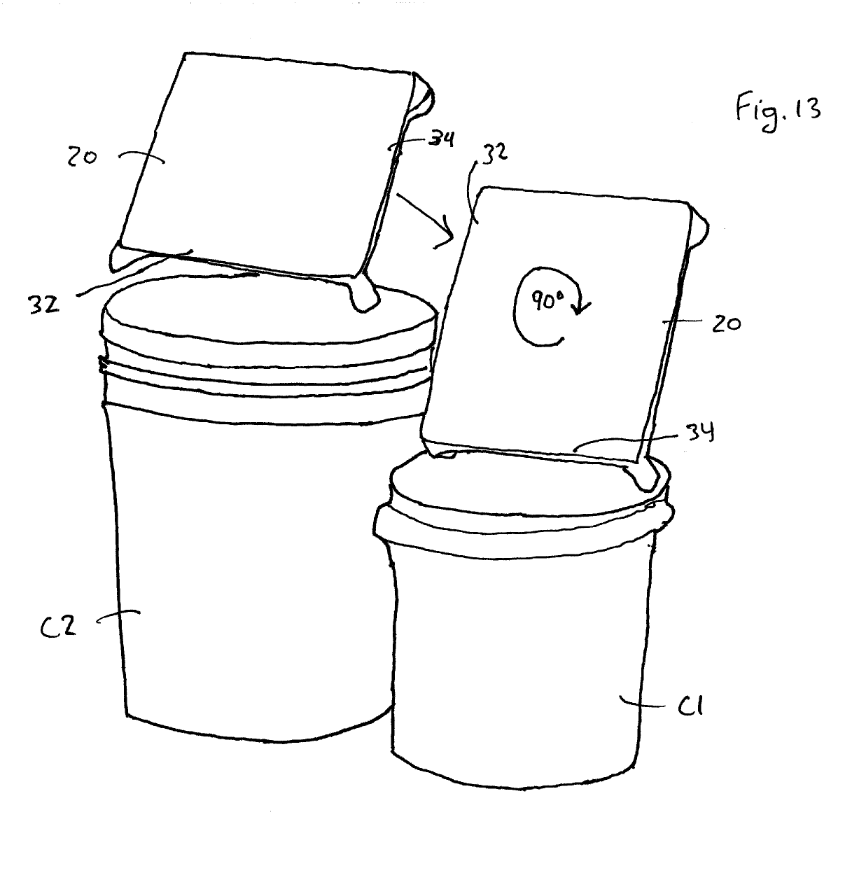

FIG. 13 illustrates an embodiment of the method in which the paint grid is first used with container C2 in the second orientation and then used with a container C1 having a different size in the first orientation. For example, container C2 could be a standard five gallon bucket and container C1 could be a standard two gallon bucket. Alternatively, container C1 could be a standard two gallon bucket and container C2 could be a standard one gallon bucket. Other combinations of differently sized sets of containers are also possible within the scope of the invention. The switch the paint grid 20 between the containers C1, C2, it is simply removed from the first container rotated (e.g., about 90 degrees) as indicated by the arrow in FIG. 13 and placed in the second container. The paint grid can be placed in the second container immediately after being removed from the first container, but it is also contemplated that placement of the paint grid in the second container could be preceded by any of the following and combinations thereof: cleaning of the paint grid; storage of the paint grid; non-use of the paint grid for a period of time; transportation of the paint grid from one work site to another work site; etc.

As illustrated in FIGS. 9-12 the container C1 is suitably lined with a plastic liner or multiple liner system 75, such as THE PAINT DAWG® liner system, which is commercially available from Dripless, Inc., of Santa Rosa, Calif. It is commonly desirable to pour paint into a container that is lined by one or more plastic liners to facilitate easy cleaning and temporary storage. For example, paint can be poured into the innermost liner of multiple nested liners lining a container, and the innermost liner can be removed once the job is completed, exposing a completely clean next liner. This allows for easier cleanup and more efficient paint storage. Liners can be thrown away without any need for wet cleanup methods. Also, when the painting process must be temporarily halted, rather than having to pour all the paint back into an original larger container, the liner can be tied off. This allows the paint to be saved for a more extended period of time without drying. Moreover, if it is necessary to return paint to its original container, the liner can be removed and a corner can be cut or a hole punched in the bottom so that all the paint can be easily returned to the original container without pouring. More paint can be saved this way than with traditional methods. However, use of liners and multi-liner systems with container-mounted paint grids risks problems because conventional paint grids often have sharp corners, edges or other features that contact the liner and which may accidentally tear or puncture the liner during use.

The position of the paint grid 20 relative to features of the container during use can vary within the scope of the invention. For example, it is possible that the paint grid 20 could be supported by contact between the two bottom legs 42 and/or feet 52 and the bottom of the container instead by the two of legs 42 and feet 52 that are hooked over the rim of the container. It is also possible that two of the radially outward facing surfaces 58 can be seated against an interior sidewall of the container, as illustrated in FIG. 11. In either of these cases, one or more of the feet 42 and/or legs 52 can contact the plastic liner or multi-liner system 75 lining the container. As illustrated in FIG. 11, the legs and/or feet that are hooked over the rim of the container C2 can also contact the liner or multi-liner system. The paint grid 20 limits the risk of damage to the liner of multi-liner system 75 because the surfaces of the legs 42 and feet that are most likely to contact the liner 75 are rounded, as described above. Thus if the legs 42 and/or feet 52 contact the liner or multi-liner system 75, there is less risk that the paint grid 20 will puncture, tear, or otherwise damage the liner.

In the embodiments in which the paint grid 20 is made out of a flexible and resilient polymeric material, it can be easily cleaned of dried paint or the like by non-plastically bending and flexing the paint grid to cause the layer of paint or other surface coating substance dried on the paint grid to separate from the paint grid and flake off. Accordingly, the dry paint or other surface coating material will easily chip off of the grid, allowing for simple and dry cleanup.

When describing the elements of this invention or the preferred embodiments thereof the term “paint” should be understood generically to include any fluid substance for which a roller applicator is a suitable device for applying the substance to a surface in the manner roller applicators are used to apply paint to a surface. In particular the term paint could refer to oil based paints, water based paints, latex paints, stains, varnishes, lacquers, primers, protectants, sealants, cleaning agents, adhesives, etc. This list is not however exhaustive.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A paint grid for removing excess fluid from a roller type applicator, the paint grid comprising a sheet of material having a plurality of openings therein, the sheet having a length and width that is less than the length, the sheet having a substantially planar central portion and sloped edge margins extending from the central portion, the sloped edge margins including a sloped edge margin extending lengthwise along one edge of the sheet and a sloped edge margin extending widthwise along another edge of the sheet.

2. A paint grid as set forth in claim 1 wherein the sheet is rectangular and the sloped edge margins extend substantially continuously along at least two adjacent sides of the rectangular sheet.

3. A paint grid as set forth in claim 2 wherein the sheet has a corner at the intersection of said at least two adjacent sides of the sheet and the corner is sloped relative to the central portion of the sheet.

4. A paint grid as set forth in claim 1 wherein the sloped edge margins have a width in the range of about [Larry—insert range(s)].

5. A paint grid as set forth in claim 4 wherein the sloped edge margins are disposed at an angle in the range of about [Larry—insert range(s)] relative to the substantially planar central portion.

6. A paint grid as set forth in claim 1 further comprising legs extending from the sheet of perforated material.

7. A paint grid as set forth in claim 6 wherein the legs are configured to hang the paint grid on an upper rim of a container so the paint grid extends into the container in a first orientation and to hang the paint grid on the upper rim of the container so the paint grid extends into the container in a second orientation, the widthwise extent of the sheet being generally horizontal in the first orientation and the lengthwise extent of the sheet being generally horizontal in the second orientation.

8. A paint grid as set forth in claim 6 wherein the legs support a plurality of feet spaced from the sheet, the feet extend radially inward from the legs toward the central portion of the sheet, the feet having radially outward facing surfaces that are rounded.

9. A paint grid as set forth in claim 6 wherein the feet angle away from the sheet as they extend from the legs radially inward.

10. A paint grid as set forth in claim 9 wherein the feet are configured to form a concave channel oriented so the open side of the channel faces generally toward the sheet.

11. A paint grid as set forth in claim 1 wherein the sheet is made of a resilient flexible polymeric material.

12. A paint grid for removing excess fluid from a roller type applicator, the paint grid comprising a sheet of material having a plurality of openings therein and legs extending from the sheet material, wherein the legs support a plurality of feet spaced from the sheet, the feet extend radially inward from the legs toward the central portion of the sheet, and the feet having radially outward facing surfaces that are rounded.

13. A paint grid as set forth in claim 12 wherein the feet angle away from the sheet as they extend from the legs radially inward.

14. A paint grid as set forth in claim 12 wherein the feet are configured to form a concave channel oriented so the open side of the channel faces generally toward the sheet.

15. A method of painting, the method comprising:
positioning a paint grid so it has a first orientation and extends into a first paint container, the paint grid including a sheet having a plurality of openings therein, the sheet having a length and a width that is less than the length;
dipping at least a portion of a roller applicator into a reservoir of paint in the first paint container to load the roller applicator with paint from the first paint container;
rolling the roller applicator up and down on the sheet of the paint grid;
using the roller applicator to paint with paint from the first paint container;
repositioning the paint grid so it has a second orientation different from the first orientation and so it extends into a second paint container, the second paint container having a different size than the first container;
dipping at least a portion of a roller applicator into a reservoir of paint in the second paint container to load the roller applicator with paint from the second paint container;
rolling the roller applicator up and down on the sheet of the paint grid; and
using the roller applicator to paint with paint from the second paint container.

16. A method as set forth in claim 15 wherein repositioning the paint grid comprises rotating the paint grid so the orientation of the paint grid relative to the first paint container is about 90 degrees different from the orientation of the paint grid relative to the second paint container.

17. A method as set forth in claim 15 further comprising non-plastically deforming the paint grid to facilitate removal of dried paint from the paint grid.

18. A method as set forth in claim 15 wherein the first and second paint containers are each lined with one or more flexible plastic bags, the paint grid has a plurality of feet having rounded surface, positioning the paint grid in the first paint container comprises positioning the feet so any contact between the paint grid and the bottoms of the flexible bags in the first paint container will occur at the rounded surfaces of one or more of the feet, and positioning the paint grid in the second paint container comprises positioning the feet so any contact between the paint grid and the bottoms of the flexible bags in the second paint container will occur at the rounded surfaces of one or more of the feet.

19. A method as set forth in claim 15 wherein positioning the paint grid so it extends into the first paint container comprises positioning the paint grid so it extends substantially all the way to the bottom of the first paint container and repositioning the paint grid so it extends into the second paint container comprises repositioning the paint grid so it extends substantially all the way to the bottom of the second paint container.

20. A method as set forth in claim 19 wherein the first paint container is a two gallon paint bucket and the second paint container is a five gallon paint bucket.
